(19) United States
(12) Patent Application Publication
(10) Pub. No.: US 2002/0188467 A1
(43) Pub. Date: Dec. 12, 2002

(54) Medical virtual resource network

(76) Inventor: Louis Eke, Herndon, VA (US)

Correspondence Address: MEREK & VOORHEES, 643 B South Washington Street, Alexandria, VA, 22314, US

(21) Appl. No.: 09/846,381

(22) Filed: May 2, 2001

(51) Int. Cl. G06F 17/60

(52) U.S. Cl. 705/2; 705/3; 705/4

(57) ABSTRACT

An information network that integrates voice interactive, text interactive and streaming video on high speed optical and satellite connection to deliver virtual information to physicians, nurses, pharmacists and patients. This virtual resource network provides the patient records upon voice command and verifies insurance coverage, searches for proper dosage, alternative drugs, evaluates pricing and availability. This virtual resource network also prepares and sends billing information, tracks patient progress and sends automatic reminders to patients. Also provided is second opinion on demand, access to universities and medical journals and treatises so that physicians are provided with the latest treatment options. The virtual resource network is not intended as a computerized doctor, but simply as an aid to physicians to improve their access to needed information and streamline insurance and pharmaceutical procedures. In order for the system to operate effectively, it is anticipated that use will be made of an electronic input device. Preferably, an electronic medical clipboard along with a multi-point pen writer, and digital recorder is used which enables hand writing recognition that is transcribed into patient's evaluation folder. The electronic clipboard is combined with a digitized voice recorder that records both patient descriptions of symptoms and doctor's or nurse's notes and questions. In addition to the electronic medical clipboard it is also advantageous to incorporate a proboscope which provides instant culture, saliva, mucus, blood and urine collector and tester with digitized color coded results as well as electronic two way voice and video feeds for contacting other medical professionals for consultation.

### FIELD OF THE INVENTION

The invention relates to immediate, seamless, interactive access and utilization of medical information for improving delivery and quality of medical services. The invention is a medical virtual resource network that brings order, control, information, collaboration, verification, security, efficiency, cost recovery and accepted procedural central standardization to the field of medical services. The medical virtual resource network uses voice activated dialogue, video streaming and function key input to access and deliver seamless service. Institutions that avail themselves of this invention will save money in system upgrades, legal suits, billing errors, avoid prescription errors, overdosing, and adverse drug combinations, enhance employee performance, enriched educational experience and satisfied customers. The medical virtual resource network collaborates with insurance providers, retail pharmacies, pharmaceutical companies and medical and research institutions.

### BACKGROUND OF THE INVENTION

The medical delivery system requires interaction between physicians, patients, pharmacies and insurance companies to deliver needed medical care. Currently, delays and paperwork frustrate the ability of the system to function smoothly. From January of 1999 to June of 1999, a random survey of clinicians, attending physicians and lab technicians at four metropolitan medical centers was conducted. The surveys centered on the role of technology and information dissemination in the elimination of errors, fraud and efficient delivery of services to patients.

Out of 250 professionals sampled, 95% of the people cited errors in prescriptions, lack of readily available clinical information, lawsuits due to improper diagnosis, poor quality, processes, lack of flexible continued education for professionals. 75% sighted fraud, delay in treatment payment, external barriers and lack of access to treatment procedures, as factors that impede good medical service delivery. The survey found that many medical centers have large electronic medical equipment, for surgery, cancer, radiation, nuclear physics etc,. but lack the necessary electronic software to network and deliver those findings from the lab or testing room to the hands of the physician and patient. The survey also found that where upgraded software exists for special tests such as ECG's, and blood/culture tests, the software link to communicate the result to the point of use is non-existent. In terms of medical drug prescriptions, fewer that 1000 medical institutions have automated paper-less prescription process linked to their internal pharmacies. Such limited information resources are unacceptable and inhibiting. For example, as anyone who has visited a hospital emergency room would know firsthand, the processing of insurance forms, and consent forms takes an unreasonably long time and contributes to the delay of treatment for medical conditions. Furthermore, when attempting to obtain prescription medicine at pharmacy, delays of several hours are common. Previous attempts have been made to alleviate some of these delays, but prior approaches have failed to see the apparent need for standardization and integration of the medical delivery system using advanced technology systems. Computerization has been applied to aspects of the medical field to advise doctors of proper diagnosis and treatment of medical conditions and verification of insurance coverage, prescription services and billing issues. However, it has not been possible to integrate these aspects together so that patient confidentiality is maintained. For example, U.S. Pat. No. 6,014,631 discloses an interactive computer assisted method which reviews and analyzes patient needs such as therapy or medication and also incorporates a medical diagnostic and treatment advice system. One of the aspects of the '631 patent is the collection of extensive information on a patient's use of medications and medical history. In the interests of patient privacy, it is important that such information not be stored in a central location since many patients would not consent to their doctor or hospital giving access to a third party database to retain this information. Therefore, the present invention, while having the ability to gather information on a specific patient as the information is entered, does not have as one of its central objects the creation of a master database to store the information on a permanent basis and therefore privacy issues are avoided. Rather the MVRN digitizes and compartmentalizes patient records allowing only needed patient profiles to be released. Furthermore, a digital card issued to patients can be required to activate use of patient medical information,(i.e. a Smart Med Card)

However, the privacy issue is not the only fault with prior attempts at computerization. Incorporation of insurance coverage as well as up-to-date information from teaching hospitals, the Food and Drug Administration, the Centers for Disease Control, journals and treatises and medical handbooks in an integrated and instantaneous format is also required to adequately improve the delivery of medical services.

In view of the foregoing it can be seen that there is a need for a new interactive and comprehensive network for assisting in the delivery of medical services.

### OBJECTS AND SUMMARY OF THE INVENTION

An object of the invention is to provide to physicians and hospitals patient insurance coverage information using intuitive electronic dialogue protocol.

Another object of the invention is to provide to physicians and hospitals patient medical history by accessing physician and/or hospital maintained databases and/or insurance databases.

Still another object of the invention is to provide physicians and hospitals with digitized electronic pharmacological information from the Food and Drug Administration, Centers for Disease Control and drug manufacturers.

Yet another object of the invention is to access retail pharmacies' drug availability, alternatives and pricing and location information to permit new prescription ordering online.

Still another object of the invention is the ability to contact patients automatically for refills of prescription medications and emergency prescription access from any location.

Yet another object of the invention is to facilitate interaction of insurance coverage for treatment of illness, status reports, negotiated/arbitrated settlement and prescription drugs.

It is a further object of the invention to provide verification of codes for security measures to prevent unauthorized access to prescription drugs as well as to ensure verification of proper drug selection using precision prescription protocol.

Yet another object of the invention is to provide an electronic clipboard for use by doctors, nurses and other medical personnel to interact with insurance companies, pharmacies, hospitals, universities and medical publications.

Still another object of the invention is to provide a proboscope for electronically obtaining patient information and electronically transmitting the collected information to hospitals, laboratories and other medical professionals.

Yet another object of the invention is the provision of master scheduling of rooms, patient visits, physician assignments, emergency second opinion.

Still another object of the invention is to provide an electronic patient diagnostic protocol to offer guidance to the understanding and treatment of patient illness.

It is a further object of the invention to provide for the use of a consortium of medical experts for complex medical treatment and procedures.

Yet another object of the invention is to provide physician access to national medical board and FDA medical procedures

Still another object of the invention is to provide a structured streamlined body of medical information with graphic animation and three dimensional viewing.

It is a further object of the invention to provide a system which improves upon electronic messaging by providing e-mail in priority order and streaming priority messages across the computer screen.

Yet another object of the invention is to provide the ability to remotely send lab test results, x-rays, ECG, and the like information to points of use eliminating hand delivery and protracted treatment time.

Still another object of the invention is to provide an electronic diagnostic protocol for medical personnel to refer to when providing medical services to patients.

Another object of the invention is to provide a medical treatment procedures to assist medical personnel in providing medical services to patients.

In summary, the present invention provides an information network that integrates voice interactive, text interactive and streaming video on high speed optical and satellite connection to deliver virtual information to physicians, nurses, pharmacists and patients. This virtual resource network provides the patient records upon voice command and verifies insurance coverage, searches for proper dosage, alternative drugs, evaluates pricing and availability. This medical virtual resource network also prepares and sends billing information, tracks patient progress and sends automatic reminders to patients. Also provided is second opinion on demand, access to teaching hospitals and medical journals and treatises so that physicians are provided with the latest treatment options. The medical virtual resource network is not intended as a computerized doctor, but simply as an aid to physicians to improve their access to needed information and streamline insurance and pharmaceutical procedures. In order for the system to operate effectively, it is anticipated that use will be made of an electronic input device. This may be as simple as a personal computer or may incorporate voice interactive technology. Preferably, however an electronic medical clipboard along with a multi-point pen writer, and digital recorder is used which enables hand writing recognition that is transcribed into patient's evaluation folder. The electronic clipboard is combined with a digitized voice recorder that records both patient descriptions of symptoms and doctor's or nurse's notes and questions. The voice interaction is transcribed into text upon request. This system is ergonomic, and portable designed to mirror standard medical writing pads. The digitized recorder uses a microphone that is detachable, easily pinned to a lapel or hidden under over-coats and transmits the signal to recorder. The digitized recorder allows the medical practitioner to document clinical evaluation without the need to write. The digital recorder preferably uploads via an 802.11 wireless network into a patient's examination folder. The electronic clipboard improves upon the current use of the stethoscope by including an adaptor attached to a recorder to connect a conventional stethoscope to the system and amplify the heartbeat and/or heart murmer up to 500 times for clarity and blocks out external sound and then autotranscribes the sound wave to a digitized cardiographic chart for better evaluation. In addition to the electronic medical clipboard it is also advantageous to incorporate a proboscope which provides instant culture, saliva, mucus, blood and urine collector and tester with digitized color coded results as well as electronic two-way voice and video feeds for contacting other medical professionals for consultation.

Other objects, uses and advantages will be apparent from a reading of this description which proceeds with reference to the accompanying drawings forming a part thereof.

### BRIEF DESCRIPTION OF THE DRAWINGS

FIG. 1 is a flow chart showing the admitting process;

FIG. 2 is a flow chart showing the electronic diagnostic system;

FIG. 2b is a flow chart showing the electronic diagnostic system coordinating with the medicare system.

FIG. 3 is a flow chart showing the flow of pharmaceutical information;

FIG. 4 is a diagram showing the levels of security;

FIG. 5 is a perspective view of the electronic clipboard;

FIG. 6 is a diagramatic view of the electronic clipboard; and,

FIG. 7 is a diagramatic view of the proboscope.

### DETAILED DESCRIPTION OF THE INVENTION

The Medical Virtual Resource Network (hereinafter “MVRN”) allows hospital labs, test centers, outside x-ray and other labs to electronically send results, images and graphic charts to the point of use without the use of courier service or delegating patients to chase after their test results. MVRN ensures that patients give their only information once. Different personnel involved in each particular case will have easy, visual interactive access to same information without querying patients. The ability of medical service providers to access medical information on the move and on demand will make their work infinitely more rewarding. Below is a table of existing applications, their limitations and the MVRN system.

| Current Application | Current uses | Limitations | MVRN System |
|---|---|---|---|
| Patient Registration | Low level software. | Embeds patient info | Logs patient info once/issue |
| software | Fragmented database. | on server and | visit card to new patients, |
| | Used by medical | desktop. | request card if regular client |
| | clerical staff | No multi-task. | Digitized patient records. |
| | | No interaction. | Hospital medical records etc. |
| | | | Codifies records in file/w |
| | | | icons. |
| | | | Auto disseminates info to |
| | | | station; lab; radiology; etc. |
| | | | Auto searches patient medical |
| | | | record updates. Flags |
| | | | conflicts. |
| | | | Prepares co-pay/billing |
| | | | Prints patient summary visit |
| | | | report. |
| | | | Eliminates paper/sign-in etc |
| Patient Diagnostic profile | Most low level | Limited electronic | Medical Electronics |
| | processing software | patient admission | Diagnostic System. |
| | Nurses and doctors | profile | Intuitive software technology |
| | rely heavily on paper | Where available, | that auto channel cases to the |
| | forms and hand | diagnostic analysis | pre-designated locations. |
| | written evaluation | is too broad. | Allows stations to remotely |
| | reports. | No link to lab or lab | send lab, radiology, billing |
| | Use of slips for blood | feed back to nursing | schedule, doctor information |
| | lab-work and nurse | station. | using special voice attention |
| | hand transfer of | Nurse station, | notice and case file icon with |
| | records. | remains paper | patient name on file jack icon. |
| | Poor use of medical | intensive. | Eliminates paper/duplication. |
| | staff time. Low | Poor manual | Performs complete suggestive |
| | bottom line hospital | tracking of doctor's | diagnostics. Verifies |
| | productivity | room schedules and | treatment procedure, receives |
| | | concerns, | results. |
| | | Doctor's inadequate | Prepares, verifies treatment |
| | | attention to form | (rehab, drug) and generates |
| | | generated patient | status/summary report. |
| | | complaint | |
| Lab/Radiology Slip | Lab technicians and | Slips are lab order | MVRN Network facilitates |
| Request (paper) | nurses. | forms written by | auto request to lab. |
| | Slips on station | hand. | Patients are directed with site- |
| | counters notify | Limited advantage. | map to lab/radiology. |
| | technicians. | Inefficient, creates | La/radiology results are auto- |
| | | delays/errors | remotely sent to appropriate |
| | | Test results take | station. |
| | | more time than | Network provides summary |
| | | necessary. | analysis of result to both |
| | | Lab software useful | Doctor/station and on |
| | | only to technicians, | patients visit summary report. |
| | | no electronic | Outside lab result transferred |
| | | transfer of data | electronically. Reduced time. |
| Patient Case Order Note | Written-up by nurse | Physicians seldom | Patient case file electronically |
| | case manager. | review case file on | documented. |
| | Attending | hand writing | EMMC enable flexibility of |
| | practitioners update | thoroughly. | case update. |
| | case file by hand | Inaccuracies and | Provides expert electronic |
| | | incomplete patient | diagnosis and treatment |
| | | complaint not | guidelines. |
| | | effectively | Provides evaluation procedure |
| | | documented. | Sends information where |
| | | Room for self | needed. |
| | | interpretation | Provides summary report for |
| | | | doctors quick analysis. |
| Typed or handwritten | Mostly written by | Limited software | Electronic Intuitive Global |
| Prescription note/New | Doctors | for internal | prescription network |
| PDA | Occasionally | prescription. | Conduct comprehensive |
| | prescribed and written | Mostly prescriptions | pharmacological analysis, |
| | by Nurses. And | are written by hand. | verifies patient current |
| | residents. | Little or no research | prescription regiment, and |
| | Doctors often dictate | on drug treatment | verifies coverage with |
| | drug treatment to | regiment. | healthcare coverage. |
| | nurse without proper | Little or no | MVRN auto check for |
| | verification. | verification and | prescription availability at |
| | | exacting | retail pharmacy nearest |
| | | mechanism. | patient residence. |
| | | No coverage | Logs prescription history to |
| | | verification with | internal server and internal |
| | | Insurance provider | pharmacy |
| | | PDA's are personal | Recommends exacting |
| | | gadgets without link | formulary and alternative |
| | | to internal server or | drug. |
| | | authorization to | System is institution |
| | | carry | registered not a PDA. |
| | | medical/patient | Maintains highest level of |
| | | records. Not a | encrypted security. Uses GPS |
| | | shared system. | security to track uses beyond |
| | | | designated areas. |
| ECG/EEG Harvest List | Standalone software | No link to outside lab. | Software will enable |
| Software Etc. | used by lab | 3-5 day delay | technicians to remotely remit |
| | technicians. | | test to lab and receive results |
| | Inaccessible at point | | from lab. |
| | of use other than | | Technician can auto distribute |
| | technician. | | result to appropriate station or |
| | | | at point of use. |
| | | | EMMC will receive lab |
| | | | result, generate summary |
| | | | analysis of result and send |
| | | | copy to serve for archive |
| | | | Software will enable results to |
| | | | attach graphic digital |
| | | | representation of findings |
| | | | (animated for clear view) |
| PDA/Devices | Used by individual | No direct link to | EMMC is a complete |
| | residents for data | institutions server. | practical system, linked to |
| | storage | Provides little or no | MIS server and to all |
| | | effect on efficiency | appropriate lab systems. |
| | | of service to patient | System is designed for multi- |
| | | or to bottom-line. | task; multi-personnel use and |
| | | | self contained. |
| | | | It is mobile, equipped to |
| | | | conduct outside links-web |
| | | | enabled. |
| | | | Used for teleconferencing, |
| | | | prescription, second opinion, |
| | | | station schedules. |
| | | | Conducts full procedural |
| | | | diagnosis etc. |

The invention will now be described with respect to the flow of information as a patient obtains treatment for a medical condition.

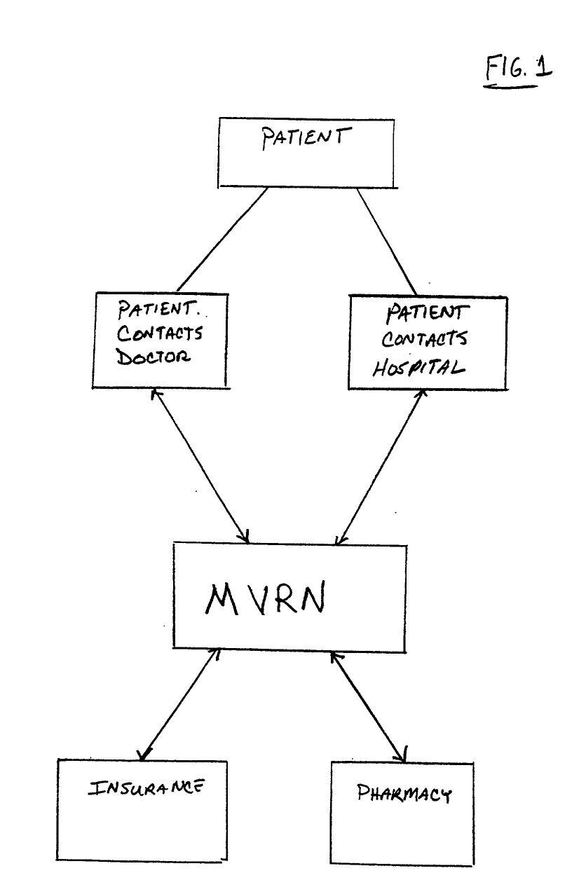

First, with reference to FIG. 1, a patient contacts a doctor. This can be accomplished either by telephone to the doctor's office or hospital. It should also be apparent that in an emergency situation, the hospital may be contacted by emergency personnel on behalf of the patient. Next the patient provides to the doctor or hospital a medical identification number and a description of medical symptoms which would indicate whether an emergency situation is present and if so what hospital is the destination. This information is automatically uploaded to the MVRN. The MVRN contacts the hospital while the patient is holding on the phone. The MVRN sends information including a primary patient record having the patient's social security number, gender, date of birth, insurance identification and the name of the patient's primary care doctor or clinic. Next the MVRN returns to patient and provides the appropriate instruction regarding proceeding to the hospital, confirming registration and instructs the patient to go to the registration desk at the hospital and pick up a treatment card.

Alternatively, the patient's information may be provided to a nurse having an electronic input device such as a personal computer or an electronic medical clipboard. A third alternative is a computer kiosk at the hospital where the patient may enter their own information electronically.

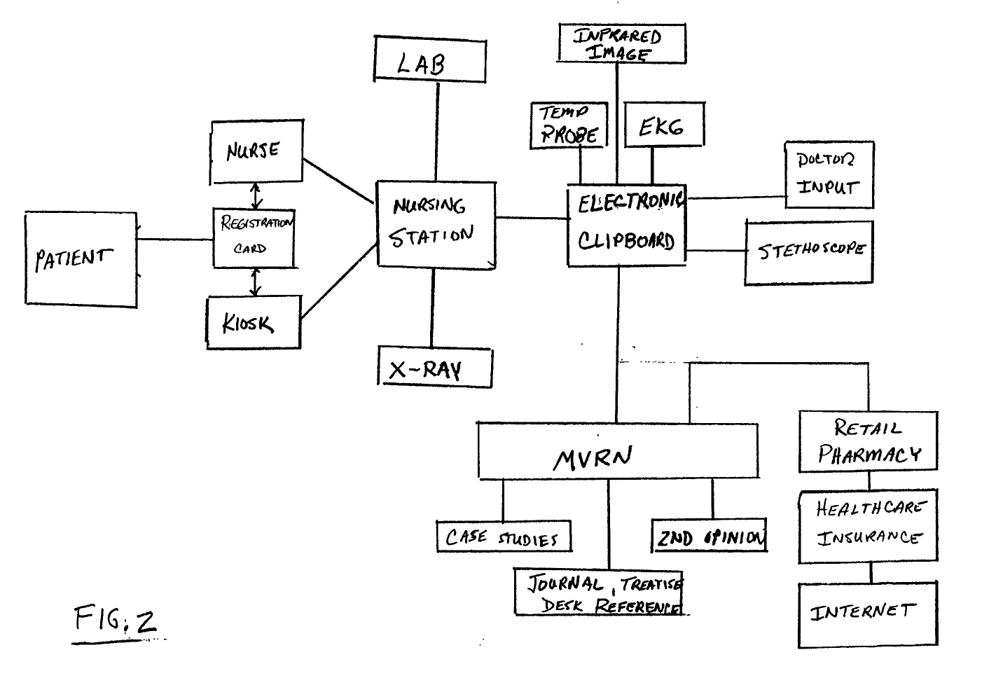

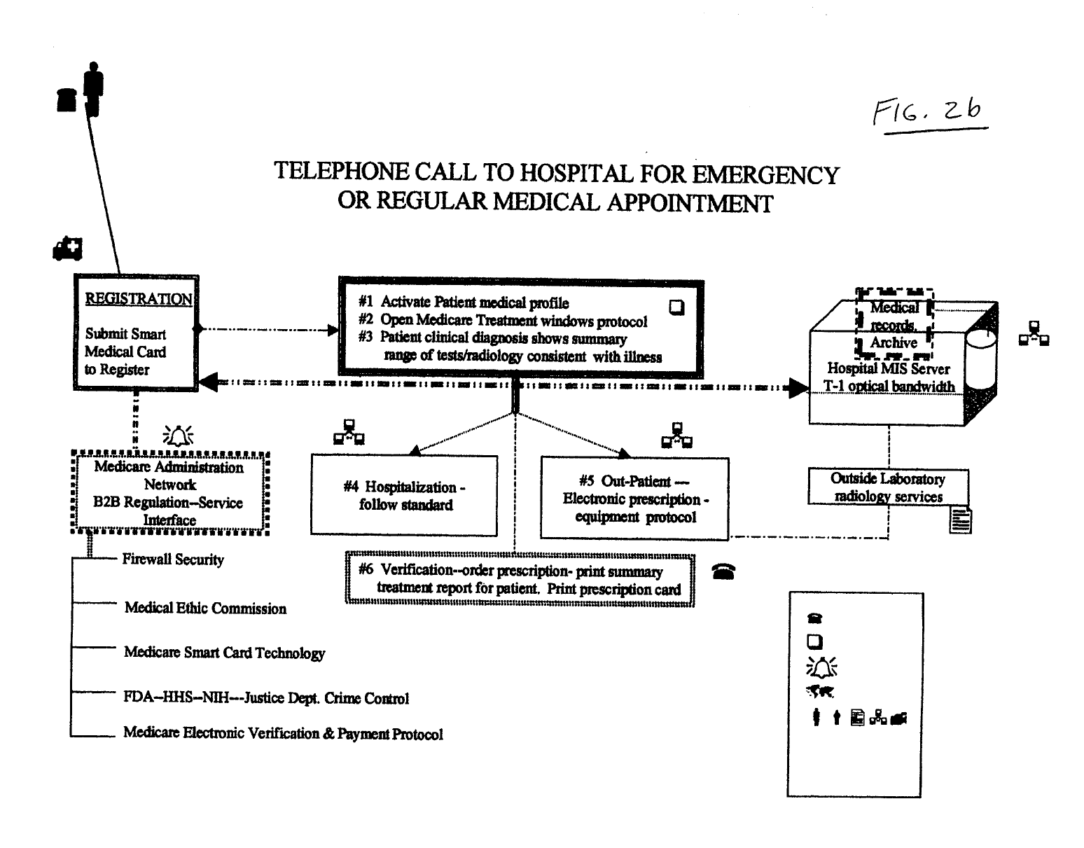

Now with reference to the flowchart of FIG. 2, the MVRN also includes an electronic diagnostic system wherein the patient responds in a question and answer session with a nurse or the kiosk while standard admitting tests are performed such as blood typing and insurance coverage is also verified. The information provided is then electronically analyzed, summarized and downloaded to the nursing station, the electronic clipboard, desktop, laboratory, X-ray department, and other hospital stations as necessary. The doctor preferably supplements this information on his electronic clipboard with notes, either verbally or written, with data from a stethoscope having a recorder, and/or a graphic EKG as well as an electronically recordable temperature probe, and preferably also has the ability to take an infrared image of the patient's throat.

The physician then has the ability to forward lab and radiology tests electronically to the hospital via the MVRN if necessary and/or forward the information to another medical professional for a second opinion from another doctor at the hospital or even a distant university or specialist. The doctor can request from the MVRN a case study to compare treatment options as well as information from treatises, journals, and physician's desk references. Next the physician writes up the treatment (or uses a voice recorder) and orders applicable tests which are analyzed and uploaded onto the clipboard or desktop or archived in the server.

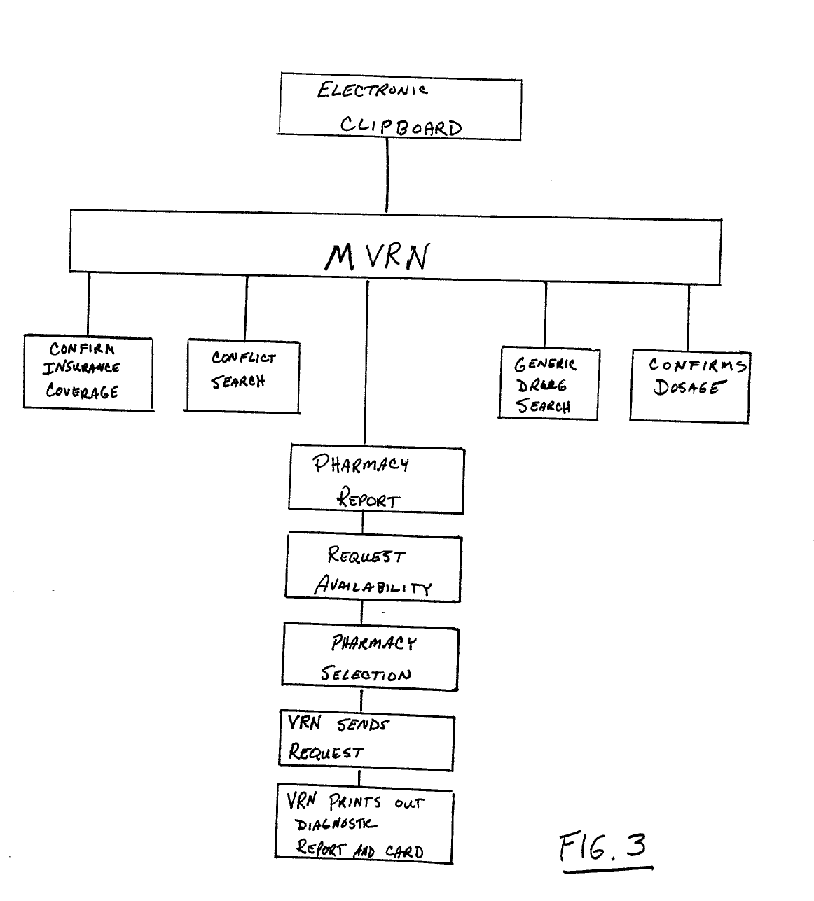

At the conclusion of the exam, the treatment and therapy has been diagnosed and insurance coverage is verified. Now with reference to the flow chart of FIG. 3, upon prescription of medication by the physician, the MVRN conducts an automatic search for a generic alternative drug, any conflict with existing therapy or condition, allergic reaction, then confirms dosage and provides the doctor and patient with a three dimensional image of the tablet or liquid formulation. The MVRN automatically reviews the patient's past medication history to ensure compatibility with the new prescription, automatically dials into the patient's health insurance carrier to confirm prescription coverage, deductible and copayment. Where there is a conflict or incompatibility with either current medication or the possibility of a allergic reaction or over or under dosage, a response will be produced by a warning flash on the electronic clipboard or desktop and voice report. Upon completion of the automatic review a green flash will appear on the screen. Next the MVRN provides a pharmacy report to the doctor on the display screen and upon review the doctor requests availability. The MVRN checks for pharmacy locations and verifies availability of the drug. Preferably, three pharmacies are located. The patient then selects a pharmacy and the MVRN sends the request to the preferred pharmacy in a file indicating the source of the request. Then the MVRN prints out a complete diagnostic report and prescription card. The patient can then take the prescription card to the pharmacy and pick up the medication which will be filled and ready for pickup. The MVRN has the capability of forwarding a copy of the report to the patient's email address if provided. Also for inpatient services and emergency services, the electronic clipboard includes icons which allows users to create electronic forms. The clipboard also tracks diets, nurse examinations, physician reviews and clinical services and documents all treatment processes from admittance through discharge.

The database for the prescription drug network would preferably include a schedule of available drugs and medical apparatus, a databank of prescription requests from the doctor or hospital and links to individual pharmacies for interactive communication to verify dosage, concentrations or alternative medical devices. The MVRN also includes a pharmacy refill prompter feature wherein the MVRN automatically dials the patient and provides the date for the next refill and can include the capability for the pharmacy to send a refill request to the doctor and provide partial dosage preclearance for those situations where a patient is on a maintenance drug. An additional pharmacy feature can include optional electronic copay with automatic bank account debiting should the patient elect this option.

In order to provide insurance verification, it is necessary for the MVRN to be able to either have a master database of insurance information or be able to access insurance coverage information on a case by case basis. The information required by the MVRN would preferably include for each insurance carrier all approved treatments for all known illnesses, all types of insurance coverage, i.e., group, individual, COBRA, medicare and medicaid, the patient's individual insurance coverage profile, billing information for the doctor/hospital, coverage request status, deductables and copay information and preferably voice response question and answer capability. By having immediate access to this information the MVRN has the capability to instantaneously verify coverage and give the medical provider with immediate confirmation of payment for service.

Now referring to FIG. 2b, the flow chart depicts the diagnostic protocol for patients having medicare coverage. Upon submission of a Smart Medical Card the MVRN contacts the medicare administration network on a business to business interface while simutaneously activating the patient's medical profile, opening the medicare treatment window protocol with a patient clinical diagnosis showing a summary of the range of tests and radiology consistant with the patient's medical condition. The MVRN will retrieve from a medical record archive and display on the medical service provider's computer screen the standards for hospitalization of the patient consistent with the medical condition or the outpatient electronic prescription protocol. Should the medical provider choose a treatment procedure outside the standard medicare protocol, that procedure will be identified (such as by an asterisk) and allowed such exception could be forwarded to a medical ethics commission for review in the future. In this way procedures outside the standard protocols for the treatment of various medical conditions can be identified to medicare for proper investigation. In this way unnecessary medical practices can be discouraged by informing medical providers of what procedures are consistent with medicare protocols and fraudulent practices can be investigated and even prosecuted by the appropriate authorities.

The MVRN displays the medicare treatment window on the medical provider's computer screen which includes menus for electronic forms, a search engine and icons for requesting approval of medical procedures and prescriptions as well as icons for other medical related functions.

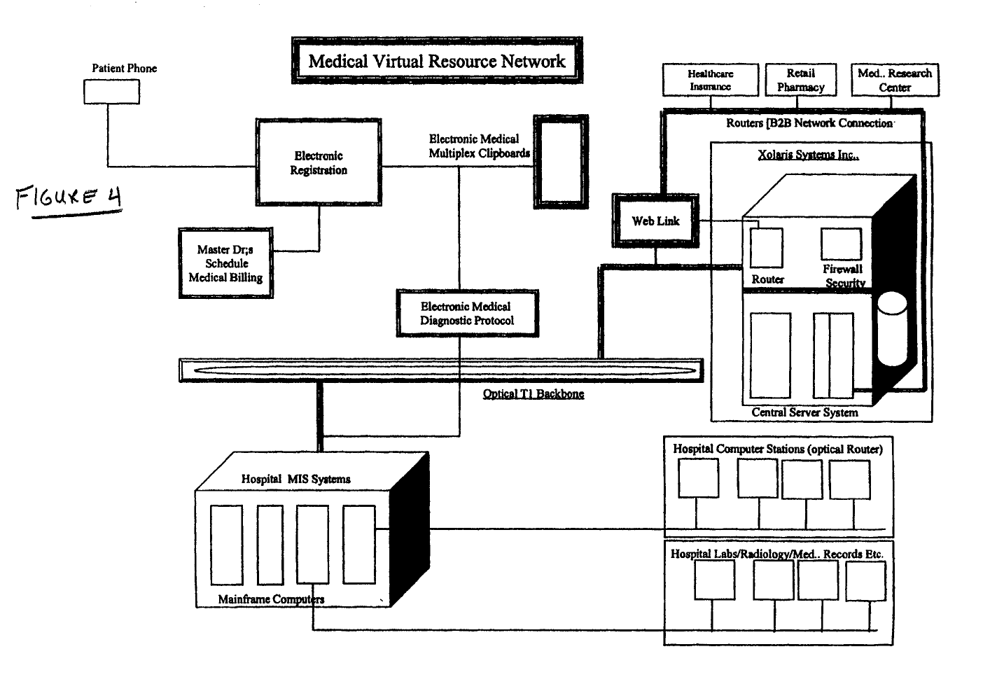

Security is a primary objective of the MVRN. The MVRN displays only the information necessary to achieve the immediate transaction. To this end, five levels of security are used. Now with reference to the schematic drawing of FIG. 4, first and most secure are the hardwired business to business connections. This connection would include direct connection from insurance companies to hospitals, hospitals to doctor's offices and insurance companies to pharmacies. The second level includes an internet web network where information is passed in encrypted format. This second level includes information transferred through the MVRN data center which links insurance providers with doctors' offices and their electronic input devices, hospitals, pharmacies, patients and government agencies, universities, journals treatises and other reference sources. While information sent to the MVRN may or may not be encrypted, it is preferred that all information sent out by the MVRN is encrypted.

A third level of security includes institutional securities such as those used by hospital computer systems or insurance companies which require passwords for access to the databases which are outside of the control of the MVRN.

A fourth level of security is the compartmentalization of information. This aspect limits the information available to specific requests. This prevents access to patient medical records unless it is related to a particular inquiry and thus ensure patient privacy.

The fifth level of security is the provision of information via CDROM. This source of information is limited to those entities who receive the copy and therefore the access to information is controlled.

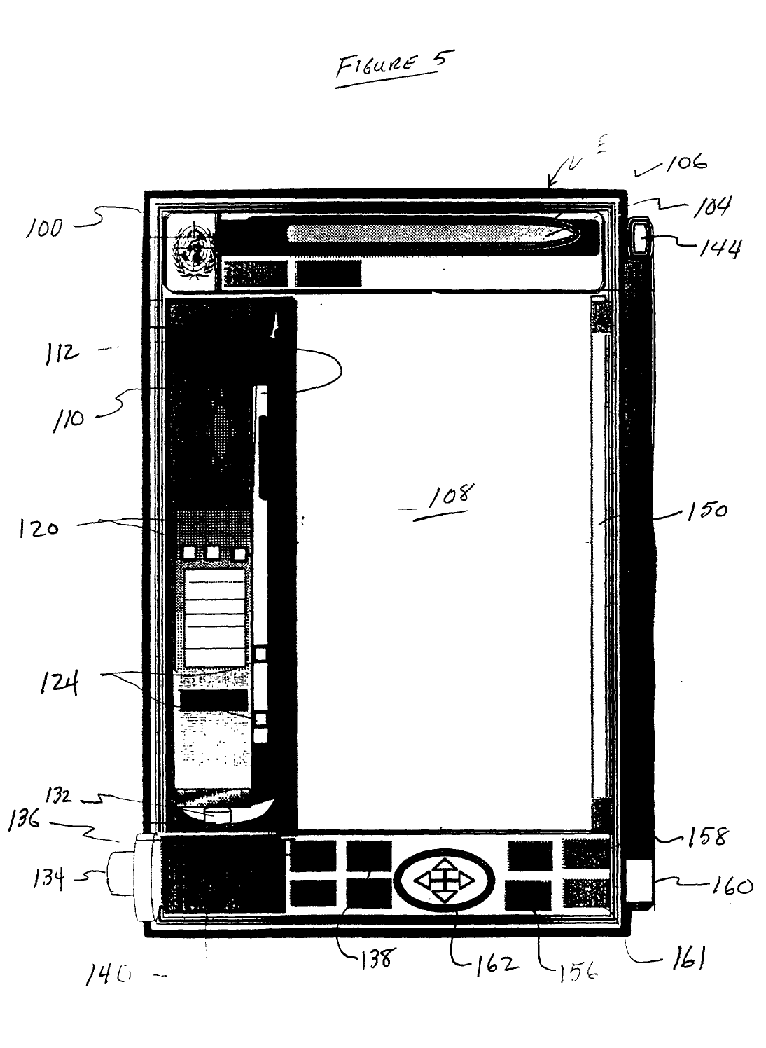

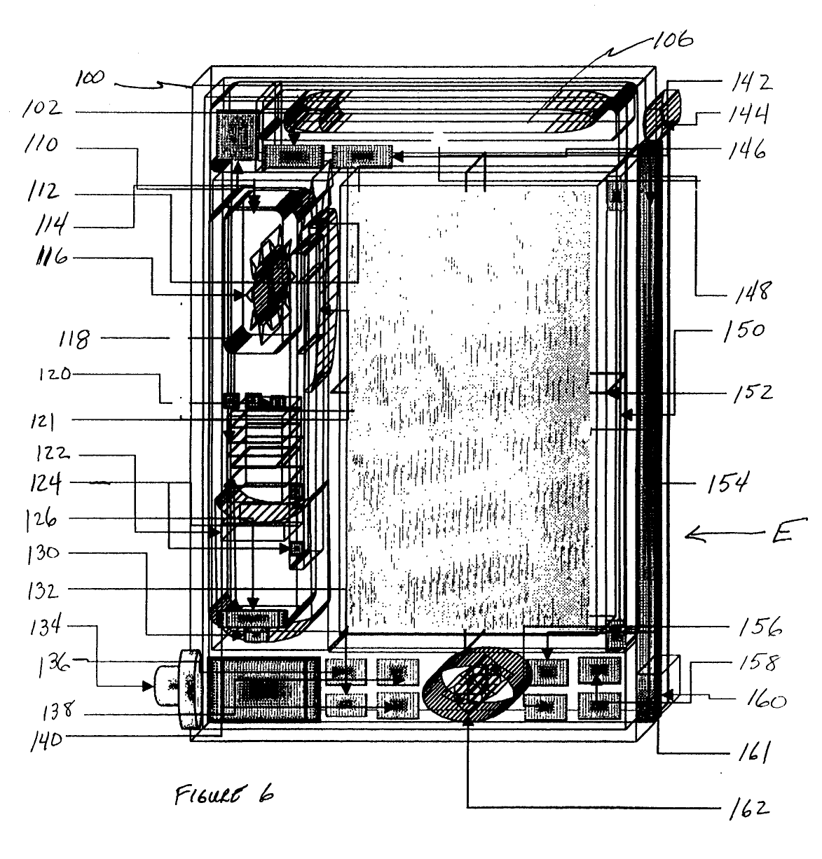

The electronic clipboard E is shown in FIGS. 5 and 6 interacts with MVRN software to use digitized patient medical records and preferably includes an embedded software resource database of directories containing nationally approved treatments such as surgery, drug therapies, etc., directories containing medical records, directory of practitioners, pharmaceutical companies, pharmacies, publications and menus of services as well as software for video conferencing.

The clip board E includes a housing 100 having the general ergonomic shape and size of a conventional clipboard and being about 12 and ½ inches long and 9 and ½ inches wide ½ to 1 inch in thickness and having thereon a menu retrieval control switch 102, an electronic digitized pen 104 which is held in a pen holder slot 106, a viewing screen 108, an electronic recorder 110, a detachable spring clip 112 for a detachable recorder, a microprocessor 114 for a stethoscope amplifier and cardiographic client writer and audio recorder, a battery 116, a built in GP-3 player 118 for embedded audio recording and playback, a set of record, playback, rewind and fast forward buttons 120, a central microprocessor with harddrive, DVD, modem 121, an infrared digital optical sound converter 122, a stethoscope adaptor socket 124, a stethoscope amplifier sound control nub 126, an internal docking connector port 130, on/off switch 132 which preferably includes an electronic access card, a USB docking board 134, a change screen button 136 which facilitates the change of the screen from a viewer to a writing tablet, a change screen button 138 for changing the screen to display incoming or stored information, button for sending prescription or insurance verification 140, the electronic sensor proboscope chamber 142, the probe chamber removable cap 144, controls for audio video view, search edit functions 146, the electronic compact proboscope 148 shown as having a pen shape for testing saliva, urine, blood, mucous, a scroll screen 150 for use as a writing pad and for viewing retrieved programs having a size of about 6×8 and ½ inches, embedded microfilm 152 for medical scans, digitized charts, x-rays and video chip processor 154, test result upload indicator lights 156 which flash red, green or yellow, prescription, lab, insurance verification request button 158, proboscope electronic adapter 160 which includes its own microprocessor, the print control button 161, the volume and channel and picture adjustment control panel 162, cd/dvd viewer player 164 for inputting information onto the ROM and a microfilm paper printer 168. Alternatively, the electronic clipboard may use either hardwired or wireless technology using preset directories to dial as well as using digital cameras for video streaming using infrared connections. It will be understood by those skilled in the art that some of these features may be omitted or may be replaced by new technologies without departing from the functionality of the electronic clipboard E.

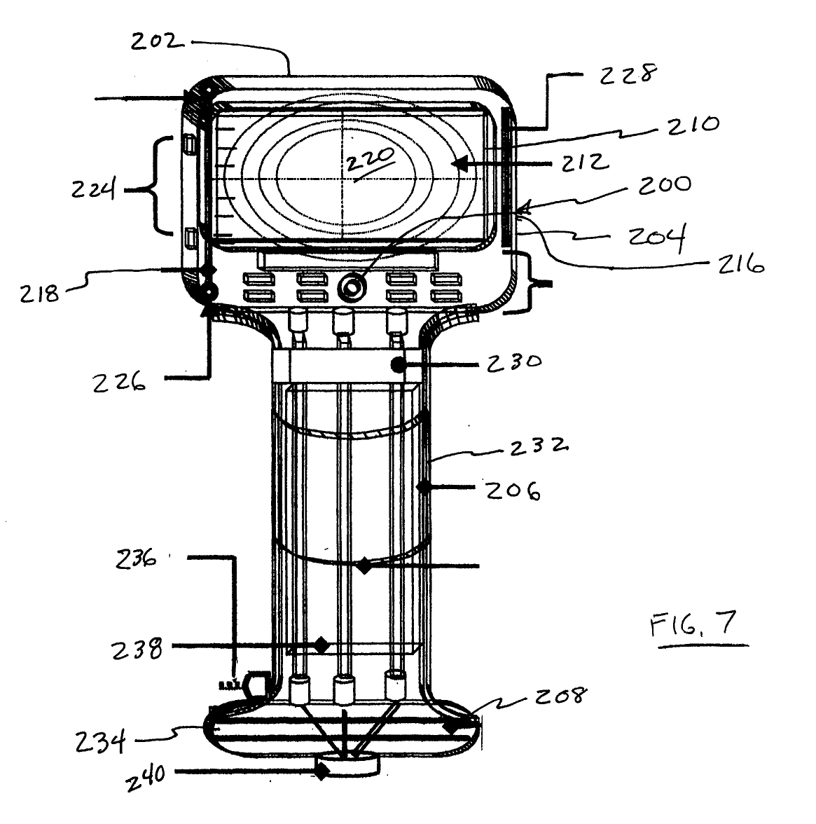

A proboscope 200 is shown in FIGS. 7 and 8. The proboscope 200 is designed to be ergonomic handheld device having a soft pliable and durable sterilizable gel plastic housing 202 having a head portion 204 preferably about 6 inches wide by 3 inches tall and about 3 inches in depth and a gripping portion 206 adjoining the head portion 204 and extending downwardly therefrom and being about 7 inches in length and 4 inches in width and approximately three inches in depth. A base portion 208 adjoins the gripping portion 206 and is spaced from the head portion 204 by the length of the gripping portion 204. The base portion 208 is about 1 and ½ inches in length and is slightly wider than the gripping portion 204 to form a knob to prevent the proboscope from slipping from the user's hand.

The proboscope 200 includes a three dimensional electronic video localized anatomy frame 210 having an SVGM LCD video view screen 212 and a control panel 214 having buttons for controlling on/off, brightness, contrast date, zoom, tint and sharpness and function navigation. Preferably, the proboscope 200 includes an optical scanning mouse 216, a digital optical laser camera 218 having a high speed optical laser light beam, a thermo-optical laser lens 220, camera controls 224, a medical laser ventricular probe tube, 226 for performing an eletrocardiogram, a digital microfilm cartridge 228, a digital sound wave digital recorder 230, a cd/dvd video disk cartridge 232, a battery 234, an electrical cable connection port 236, a microprocessor 238 and a docking station USB adapter port 240.

The proboscope 200 can be used in two distinct settings i.e., in-hospital emergency use and in the field for remote trauma clinic use. In the hospital setting, the proboscope 200 can be used by doctors or nurses by the following steps. First the power is supplied to the proboscope 200 by battery 234 or by wired connection from a power source such as a wall plug (not shown) to the connection port 236. Next the system is turned on via a button at the control panel 214 and a desired function such as the camera 218 is set via another button at the control panel 214. A digital film cartridge 228 is inserted into the proboscope and a part of the patient's anatomy is selected for examination by from an on screen menu or by voice activation. A protective sterile cover is then placed over the front lens 220, a gel is applied to the portion of the patient's anatomy being reviewed, the record button from the control panel 214 is pressed to engaged the camera 218. The probe is moved or gyrated to provide an angular picture and the save button from the control panel 214 is pressed to save the recording on the digital cartridge 228 or remotely send the data to a desktop computer or an electronic clipboard or to a printer via conventional technology such as infrared transmission.

In an emergency field situation, the proboscope is operated in the same manner as in hospital use with the exception that the power source will be solely a battery data is transmitted via wireless internet connection or wireless telephone connection. Also in the field, the thermosensing laser lens 220 can be used to determine the location of bone fracture, a bullet or internal injury as well as body temperature and blood pressure and then the proboscope 200 indicates treatment instructions via voice or on screen 212. The patient's comments can be recorded. Using the ventricular probe tube 226, an ECG can be recorded by attaching an ECG sensor to the probe tube and to the patient. The proboscope 200 also can be used to send a distress call to a hospital and request ambulance service.

While this invention has been described as having a preferred design, it is understood that it is capable of further modifications, uses and/or adaptations of the invention following in general the principle of the invention and including such departures from the present disclosure as come within the known or customary practice in the art to which the invention pertains and as maybe applied to the central features hereinbefore set forth, and fall within the scope of the invention and the limits of the appended claims.

I claim:

1. A network of medical databases for facilitation the delivery of medical services, comprising:
a) central server for providing electronic data transmission from a hospital computer system, an insurance computer system and a pharmacy computer system through said central server using internet and T1 connections;
b) a database in said hospital computer system which contains patient information and is accessible by medical personnel through an electronic input device;
c) a database in said insurance computer system which contains subscriber coverage information corresponding to said patient information whereby said medical personnel can determine insurance coverage electronically by sending patient information to said central server which automatically extracts said subscriber information from said insurance computer system database and delivers said information to said electronic input device, and
d) a database in said pharmacy computer system containing drug information whereby said medical personnel can determine said drug information by sending said patient information to said central server which automatically extracts said drug information from said pharmacy computer system database and delivers sadi drug information to said electronic input device.

2. The network as set forth in claim 1, wherein;
a) said patient information includes patient identification information.

3. The network as set forth in claim 1, wherein;
a) said patient information includes patient medical record information.

4. The network as set forth in claim 1, wherein;
a) said drug information includes drug availability information.

5. The network as set forth in claim 1, wherein;
a) said patient information includes drug history information and said drug information includes drug interaction information, whereby a drug interaction warning is sent to said electronic input device when a drug interaction is detected.

6. The network as set forth in claim 1, wherein;
a) said electronic input device is an electronic medical clipboard.

7. The network as set forth in claim 6, wherein;
a) said electronic medical clipboard contains function keys for inputting function commands and further includes an electronic writing pad.

8. A method of facilitating the delivery of medical services comprising the steps of;
a) connecting a network of databases relating to the delivery of medical services including a first database containing patient medical records, a second database containing patient insurance information and a third database containing pharmaceutical information,
b) connecting said network of databases to a central server system by internet and T1 paths;
c) entering database inquiries using an electronic input device connected to said network, whereby said central server system evaluates said inquiry and retrieves relevant information from said databases in response to said query and delivers said information to said electronic input device.

9. The method as set forth in claim 8, wherein;
a) entering said database inquiries includes requesting insurance coverage information with respect to a specific patient.

10. The method as set forth in claim 8, wherein;
a) entering said database inquiries includes requesting insurance coverage information with respect to a specific patient.

11. An electronic input device comprising:
a) a housing containing a power source, a viewing screen, a microprocessor for facilitating the transfer and storage of information in response to the actuation of function keys for operating medical input devices attached to said housing and means for transmitting stored information.

12. The electronic input device as set forth in claim 11, further comprising;
a) a medical probe for testing saliva.

13. The electronic input device as set forth in claim 11, further comprising;
a) a medical probe for testing blood.

14. The electronic input device as set forth in claim 11, further comprising;
a) a medical probe for testing mucous.

15. The electronic input device as set forth in claim 11, further comprising;
a) a medical probe for performing an ECG.

16. The electronic input device as set forth in claim 11, further comprising;
a) an adaptor for receiving input from a stethoscope

17. The electronic input device as set forth in claim 16, further comprising;
a) a recorder for recording said input from said stethoscope.

18. The electronic input device as set forth in claim 16, further comprising;
a) an amplifier for amplifying said input from said stethoscope.

19. The electronic input device as set forth in claim 11, further comprising;
a) an optical thermal lens for diagnosing medical conditions.

20. The electronic input device as set forth in claim 11, further comprising;
a) a digital camera for filming a patient's anatomy.
